(19) United States
(12) Patent Application Publication
(10) Pub. No.: US 2012/0279752 A1
(43) Pub. Date: Nov. 8, 2012

(54) INSULATED WIRE, ELECTRICAL EQUIPMENT, AND METHOD OF PRODUCING AN INSULATED WIRE

(76) Inventors: Makoto Oya, Tokyo (JP); Daisuke Muto, Tokyo (JP); Yousuke Kokubo, Tokyo (JP); Akira Tanaka, Tokyo (JP)

(21) Appl. No.: 13/551,073

(22) Filed: Jul. 17, 2012

Related U.S. Application Data
(63) Continuation of application No. PCT/JP2011/060482, filed on Apr. 28, 2011.

(30) Foreign Application Priority Data
May 6, 2010 (JP) 2010-106766

(51) Int. Cl. H01B 3/30; H01B 13/06

(52) U.S. Cl. 174/110 SR; 427/58

(57) ABSTRACT

An insulated wire, having a conductor whose outer circumference is covered with an insulating film, in which the insulating film is composed of a cured product of a thermosetting resin composition containing a thermoplastic resin, and the insulating film has fine air holes.

### TECHNICAL FIELD

The present invention relates to an insulated wire that can be used in various electrical equipments. Further, the present invention relates to an electrical equipment, such as an electrical motor and a transformer, in which the insulated wire is used. Further, the present invention relates to a method of producing the insulated wire.

### BACKGROUND ART

Since from the past, an insulated wire in which a conductor is covered with an insulating film has been used in an electrical coil for various electrical equipments, such as motors and transformers. The insulating film of the insulated wire to form the electrical coil, is required to have adhesion to the conductor, electrical insulating property, and heat resistance. Especially in recent years, electrical equipments for aerospace use, electrical equipments for aircrafts, electrical equipments for nuclear power, electrical equipments for energy, and electrical equipments for automobiles, are required not only to be reduced in size and weight thereof but also to have higher performance. For example, transformers and rotating electrical machines, such as motors, are required to have a higher output power ever than before.

Rotating electrical machines are produced, by inserting an insulated wire that is wound around a core, with pushing into a slot. To push and insert the insulated wire into the slot as much as possible, requirement is increasing for a further thinner insulating film of the insulated wire. Thus, an enhancement in dielectric breakdown voltage of the insulated wire is considered to be indispensable. Further, an insulated wire having a thin insulating film is required, which is capable of reducing damage of the insulating film, which damage is caused upon inserting, into the slot, the insulated wire.

Further, a corona discharge may occur between the insulated wire and the slot and between insulated wires themselves, when a high voltage is applied at the time of operation of the rotating electrical machine. In the case where the applied voltage is not so high, requirement of corona-discharge resistance in an insulated wire was not so high. However, because a high voltage is applied in a rotating electrical machine with a high output power, an insulated wire is required, which is excellent in the corona-discharge resistance and high in the partial discharge-occurring voltage.

To enhance the partial discharge-occurring voltage of an insulated wire, thickening of the insulating film is assumingly effective. However, in view of requirement of a thinner insulated wire, thickening of the insulating film is difficult. Usually, an insulated wire is produced by applying and baking a resin varnish onto a conductor repeatedly. To thicken the insulating film, the number of times for passing through a baking furnace increases in a production process thereof, whereby making a film composed of copper oxide on a copper conductor surface thicker, this in turn, causing lowering in adhesion between the conductor and the insulating film.

As another method to enhance the partial discharge-occurring voltage of the insulated wire, use may be made of a resin low in a dielectric constant in the insulating film. However, such a use of the resin low in the dielectric constant is difficult, because the resin is usually low in a surface free energy and poor in the adhesion with the conductor.

Further, an insulated wire is proposed, which has an enhanced corona-discharge resistance, by blending a particle into the insulating film. For example, there are proposals of an insulating film containing a particle composed, for example, of alumina, silica, and chromium oxide (see, Patent Literatures 1 and 2) and an insulating film containing a particle composed, for example, of nitrogen carbide and silicon nitride (see, Patent Literature 3). In these insulated wires, an erosion deterioration due to corona discharge is tried to be reduced, owing to the insulating film containing the particle. However, in the insulated wire having the insulating film containing the particle, flexibility of the film lowers to result in that a film surface may become rough in many cases. Due to this rough film surface, it is difficult to insert the insulated wire into a slot. As a result, depending on the case, the insulated wire is poor in the abrasion resistance and the insulating film is apt to be damaged.

### CITATION LIST

### Patent Literatures

Patent Literature 1: JP-A-57-2361 (“JP-A” means unexamined published Japanese patent application)
Patent Literature 2: JP-A-2-106812
Patent Literature 3: JP-A-11-130993

### SUMMARY OF INVENTION

### Technical Problem

The present invention is contemplated for providing an insulated wire, which has a high partial discharge-occurring voltage and a high dielectric breakdown voltage, and which is excellent in abrasion resistance. Further, the present invention is contemplated for providing an electrical equipment in which the insulated wire is utilized, which is excellent in durability. Still further, the present invention is contemplated for providing a method of producing the insulated wire.

### Solution to Problem

The inventors of the present invention studied extensively, to solve the problems above. Specifically, we studied on a method to lower a dielectric constant and raise a partial discharge-occurring voltage, by containing air holes in an insulating film of an insulated wire, even if the above particle is not contained in the insulating film provided on an outer circumference of a conductor in the present invention, in stead of containing the particles in the insulating film as described in the foregoing patent literatures. We found that, when the insulating film was foamed by containing a foaming agent into a resin varnish, a diameter of the resultant air holes became too large to lower the dielectric breakdown voltage. Then, we, having studied further, found that an insulated wire, having an insulating layer formed from a resin varnish that contains a thermosetting resin and a thermoplastic resin and that is applied onto a conductor followed by baking, with the insulated wire having fine air holes in the insulating film, can raise a partial discharge-occurring voltage, without lowering a dielectric breakdown voltage, and is excellent in abrasion resistance. The present invention is attained, based on those findings.

According to the present invention, there is provided the following means:

<1> An insulated wire, having a conductor whose outer circumference is covered with an insulating film, wherein the insulating film is composed of a cured product of a thermosetting resin composition containing a thermoplastic resin, and the insulating film has fine air holes;
<2> The insulated wire according to <1>, wherein an average diameter of the air holes is 1 μm or less;
<3> The insulated wire according to <1> or <2>, wherein a ratio A/B is within the range of 10/90 to 90/10, in which A is a mass of a resin component of the thermosetting resin, and B is a mass of the thermoplastic resin;
<4> The insulated wire according to any one of <1> to <3>, wherein the thermoplastic resin is an amorphous resin;
<5> The insulated wire according to any one of <1> to <4>, wherein the amorphous resin is at least one selected from the group consisting of a polyetherimide, a thermoplastic polyimide, a polycarbonate, a polyethersulfon, a polyphenylsulfone, a polysulfone, and a polyarylate;
<6> The insulated wire according to any one of <1> to <5>, wherein the thermosetting resin is at least one selected from the group consisting of a polyester, a polyimide, and a polyamideimide;
<7> An electrical equipment, which comprises the insulated wire according to any one of <1> to <6>; and
<8> A method of producing an insulated wire, comprising the steps of:

applying a resin varnish containing a thermosetting resin and a thermoplastic resin onto an outer circumference of a conductor directly or indirectly, followed by baking, thereby for forming an insulating film;

keeping the resultant insulating film in an atmosphere of an inert gas under a pressurized condition, thereby for bringing the inert gas be contained into the resultant insulating layer composed of the resin varnish baked; and

heating the resultant insulating layer composed of the resin varnish baked, under a usual pressure, thereby for forming air holes.

### Advantageous Effects of Invention

The present invention can provide the insulated wire, which has a high partial discharge-occurring voltage and a high dielectric breakdown voltage, and which is excellent in abrasion resistance. Further, the present invention can provide the electrical equipment, which is excellent in durability, by using the insulated wire. Further, the present invention can provide the method of producing the insulated wire.

Other and further features and advantages of the invention will appear more fully from the following description, appropriately referring to the accompanying drawings.

### BRIEF DESCRIPTION OF THE DRAWINGS

FIG. 1 is a cross-sectional view showing an embodiment of the insulated wire of the present invention, showing in (a) and (b) different embodiments of the cross section shape thereof.

FIG. 2 is a cross-sectional view showing another embodiment of the insulated wire of the present invention.

### MODE FOR CARRYING OUT THE INVENTION

A preferred, insulated wire of the present invention will be explained, with reference to the drawings.

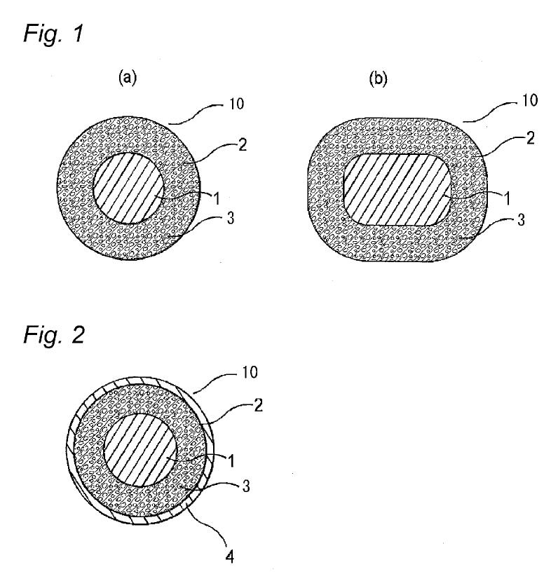

FIG. 1 is a schematic cross-sectional view showing a preferred embodiment of the insulated wire of the present invention. As can be seen in FIGS. 1(a) and 1(b), in an insulated wire 10 of the present invention, an outer circumference of a conductor 1 is covered with an insulating film 2. The insulating film 2 has at least one insulating layer, which is formed by applying a resin varnish containing a thermosetting resin and a thermoplastic resin onto the outer circumference of the conductor directly or indirectly, followed by baking. The insulating film 2 has fine air holes 3 in the said insulating layer. The conductor may be of a circular shape in its cross section, as shown in FIG. 1(a), or may be of a rectangular shape in its cross section, having rounded corners, as shown in FIG. 1(b).

Examples of the conductor 1 include those having been used from the past as a conductor of an insulated wire, such as copper, a copper alloy, aluminum, an aluminum alloy, or a combination of those.

### 1. Thermosetting Resin

The insulating film in the present invention is formed by applying the resin varnish containing a thermosetting resin and a thermoplastic resin onto the outer circumference of the conductor, directly or indirectly, followed by baking. Consequently, the insulating film is formed of a cured product of a thermosetting resin composition containing the thermoplastic resin. In the present invention, the thermosetting resin contained in the resin varnish becomes the cured product after applying and baking, to form the insulating film. This insulating film may be formed on the outer circumference of the conductor, via another layer. The insulated wire can be used, for example, for coils for electrical equipments, such as inverter-related equipments, high-speed switching devices, rotating electrical motors driven by inverters, and transformers, or for magnet wires or the like, for electrical equipments for aerospace use, electrical equipments for aircrafts, electrical equipments for nuclear power, electrical equipments for energy, and electrical equipments for automobiles.

As the thermosetting resin, use may be made of any of various kinds, as long as it does not impair the actions/effects of the present invention. For example, use may be made of any of polyimides, polyamideimides, polyesterimides, polyetherimides, polyesters modified with polyimidehydantoins, polyamides, formals, polyurethanes, polyesters, polyvinylformals, epoxies, polyhydantoins, melamine resins, phenol resins, urea resins, and polybenzoimidazoles. Among them, resins, such as polyesters, polyimides, and polyamideimides, are preferable, in view of heat resistance and flexibility. Further, these may be used singly, or as a mixture of two or more of them.

As the polyester resin, use may be made of an aromatic polyester modified by adding a phenol resin or the like. For example, use may be made of a polyester resin whose heat resistance is of an H-class. Examples of the commercially available H-class polyester resin include Isonel 200 (trade name, manufactured by Schenectady International, Inc.).

As the polyimide resin, use may be made, for example, of a thermosetting polyimide of a commercially available product (trade name, #3000 and the like, manufactured by Du Pont-Toray Co., Ltd.); or of a thermally cured product, obtained by a usual method in which a polyamide acid solution obtained by the reaction of an aromatic tetracarboxylic dianhydride with an aromatic diamine in a polar solvent is imidized by a heat treatment in the course of baking, to form the film.

As the polyamideimide resin, use may be made of a commercially available product (for example, trade name, HI 406, manufactured by Hitachi Chemical Co., Ltd.); or of one obtained by a usual method in which, for example, a tricarboxylic anhydride and a diisocyanate are allowed to cause direct reaction in a polar solvent, or alternatively firstly a tricarboxylic anhydride is allowed to cause a reaction with a diamine in a polar solvent, to introduce an imido bond, followed by amidation with a diisocyanate.

### 2. Thermoplastic Resin

The insulating film of the insulated wire of the present invention is formed by applying the resin varnish containing a thermosetting resin and a thermoplastic resin onto the outer circumference of the conductor, directly or indirectly, followed by baking. There is no particular limitation to a method of producing this resin varnish. For example, a thermoplastic resin described below is taken into a solvent, and then this thermoplastic resin is dissolved in the solvent, preferably by mixing under heating. Then, preferably, a thermosetting resin dissolved in a solvent is added into the solvent in which the thermoplastic resin is dissolved, followed by mixing under heating, to give the resin varnish containing the thermosetting resin and the thermoplastic resin.

By applying the resin varnish onto the outer circumference of the conductor and then baking, in the thermoplastic resin dissolved in the resin varnish, particles of the thermoplastic resin can be finely dispersed into a network structure of the thermosetting resin. Air holes are formed in the thus-finely-dispersed thermoplastic resin particles. At that time, by forming the air holes in a part of the thermoplastic resin particles, fine air holes can be formed in the insulating film of the insulated wire.

As the thermoplastic resin, any of heat-resistant thermoplastic resins is preferable. For example, use may be made of any of polyphenylenesulfides, polyethyleneterephthalate, polyethylenenaphthalate, polybutyleneterephthalate, liquid-crystal polymers, thermoplastic polyamide resins, polyether ether ketones, polycarbonates, polyethersulfones, polyetherimides, polyethersulfones, polyphenylsulfones, polysulfones, polyarylates, and thermoplastic polyimides. As the thermoplastic polyimide, use may be made, for example, of Aurum (trade name) manufactured by Mitsui Chemicals, Inc.

Among the thermoplastic resins, amorphous thermoplastic resins are preferable. In the present invention, as the amorphous thermoplastic resin, use may be made, for example, of any of acryl resins, norbornene resins, cycloolefin resins, polystyrenes, polycarbonates, polyethersulfones, polyetherimides, polyethersulfones, polyphenylsulfones, polysulfones, polyarylates, and thermoplastic polyimides. Among the amorphous thermoplastic resins, a particular preference is given to polyetherimides, polycarbonates, polyethersulfones, polyphenylsulfones, polysulfones, polyarylates, and the like. By using any of amorphous thermoplastic resins, it becomes readily to dissolve into a solvent. Further, these resins can be finely dispersed in the network structure of the thermosetting resin; and thus, fine air holes can be formed. These resins may be used singly, or as a mixture of two or more of those.

When A represents a mass of the resin component of the thermosetting resin not containing any solvent and B represents a mass of the thermoplastic resin, the ratio A/B is preferably in the range of 10/90 to 90/10. The ratio A/B is more preferably in the range of 30/70 to 70/30, and particularly preferably in the range of 40/60 to 60/40. If the mass of the resin component of the thermosetting resin is too large and the mass of the thermoplastic resin is too small, the part where air holes are formed becomes small so that the effect to lower the dielectric constant cannot be exhibited sufficiently, to lower the partial discharge-occurring voltage. On the contrary, if the mass of the resin component of the thermosetting resin is too small and the mass of the thermoplastic resin is too large, the abrasion resistance may become insufficient.

The thermosetting resin and the thermoplastic resin mentioned above each may be used singly, or as a mixture of two or more of the same. In the present invention, use may be made to be blended of any of various additives, such as a crystallization nucleating agent, a crystallization accelerating agent, a foam nucleating agent, an oxidation inhibitor, an antistatic agent, an anti-ultraviolet agent, a light stabilizer, a fluorescent brightening agent, a pigment, a dye, a compatibilizing agent, a lubricating agent, a reinforcing agent, a flame retardant, a crosslinking agent, a crosslinking aid, a plasticizer, a thickening agent, a thinning agent, a filler (e.g. inorganic particles), and an elastomer, as long as the actions/effects of the present invention are not affected.

### 3. Air Holes

It is preferable that the insulated wire of the present invention has, as shown in FIG. 2, an insulating layer 2 having fine air holes, and a layer 4 not having any air holes (hereinafter, referred to also as “skin layer”). The skin layer may be formed outside the insulating layer having fine air holes, as shown in FIG. 2. Alternatively, the skin layer may be formed inside the insulating layer, or may be formed both inside and outside the insulating layer (not shown in figures). In the case of providing the skin layer, in order not to impair the actions/effects of lowering the dielectric constant, the total thickness of the skin layer is preferably 70% or less, and more preferably 30% or less, to the overall thickness of the insulating film. By providing the outside skin layer, surface smoothness is improved, to improve the insulating property. Further, abrasion resistance and mechanical strength, such as tensile strength, can be secured.

To form the outside skin layer, a resin film may be laminated on the insulating layer having air holes, or a coating containing the additive mentioned above may be applied to coat the surface.

The air hole magnification (porosity magnification) is preferably 1.1 or more, and more preferably 1.5 or more. By satisfying this, the specific dielectric constant necessary to obtain an effect to improve the partial discharge-occurring voltage can be secured. If the air hole magnification is too high, the abrasion resistance cannot be maintained because the resin becomes too soft. If the air hole magnification is too low, an effect to suppress the partial discharge becomes small.

The air hole magnification in the present invention is the value calculated by: measuring a density (ρf) of the insulating film before formation of air holes formed by applying the resin varnish containing a thermosetting resin and a thermoplastic resin, followed by baking, and a density (ρs) of the insulating film after formation of the air holes, by a water-displacement method; and calculating the air hole magnification as a ratio of (ρf/ρs) with those densities.

The method to form fine air holes in the insulating film of the insulated wire of the present invention is not particularly restricted. The average diameter of the air holes is preferably 1 μm or less. By satisfying this, the dielectric breakdown voltage can be kept at a high value. The average diameter of the air holes is more preferably 0.8 μm or less. Usually, the average diameter of the air holes is in the range of 0.1 to 1 μm. If the diameter of the air holes is too large, the dielectric breakdown voltage becomes lowered. The average diameter of the air holes can be measured, by observation of the film portion having air holes with a scanning electron microscope (SEM).

As the method to form fine air holes in the insulating film of the insulated wire of the present invention, use may be made, for example, of a method described below. After applying the above-mentioned resin varnish onto the outer circumference of the conductor, followed by baking, the resultant insulating film is impregnated with a gas, followed by heating, thereby allowing fine air holes to form. To explain in more detail, the insulated wire having fine air holes formed in the insulating film can be produced by the method comprising the steps of: keeping the conductor, to which the resin varnish is applied and baked, in an atmosphere of an inert gas under a pressurized condition, to have the inert gas contained into the layer of the resin varnish baked; and heating the layer of the resin varnish baked under a normal pressure, to form the air holes.

The insulated wire of the present invention can be produced, for example, as following. That is, the above-mentioned resin varnish applied and baked onto the outer circumference of the conductor is wound around a bobbin, to stack the resultant insulating film with a separator alternately. Then, the entirety of the bobbin is kept in an atmosphere of an inert gas under a pressurized condition, to have the inert gas contained thereinto. Then, the resultant bobbin is heated at the temperature equal to or higher than a softening temperature of the thermoplastic resin used in the resin varnish under a normal pressure, to form air holes in the insulating film. The separator utilized here is not particularly restricted, as long as it makes possible for the applied-and-baked layer of the resin varnish to be impregnated with the inert gas. For example, a sheet or a film of polyethyleneterephthalate may be used. The size of the separator may be adjusted appropriately, in accordance with width of the bobbin.

Alternatively, after the applied-and-baked layer of the resin varnish is brought to contain the inert gas, it is possible to have the resultant insulating film pass through a hot-air furnace heated to the temperature equal to or higher than a softening temperature of the thermoplastic resin under a normal pressure, to continuously form air holes in the insulating film to produce the insulated wire.

Examples of the inert gas include helium, nitrogen, carbon dioxide, and argon. The penetration time period of the inert gas and the penetration amount of the inert gas to reach the saturation state of the air holes, can be set appropriately, in accordance with the kind of the thermoplastic resin in which air holes are formed, the kind of the inert gas, the pressure for penetration, and the thickness of the insulating layer having air holes. Carbon dioxide is preferable, in view of a fast penetration speed of the gas into the thermoplastic resin and a high solubility of the gas therein.

The insulated wire of the present invention has a high dielectric breakdown voltage and a high partial discharge-occurring voltage, and is excellent in the abrasion resistance, and thus, the insulated wire can be used in various electrical equipments, such as motors and transformers.

### EXAMPLES

The present invention will be described in more detail based on examples given below, but the invention is not meant to be limited by these.

### 1. Preparation of Insulated Wire

### Example 1

### Preparation of Resin Varnish Containing Thermoplastic Resin and Thermosetting Resin

Into a 2-L separable flask, 1,600 g of NMP (2-methylpyrrolidone) was placed, and thereto, 400 g of pellets of a polyetherimide resin (PEI), which is a thermoplastic resin, was added in small portions. The resultant mixture was heated to 110° C., followed by stirring for 5 hours, to obtain a yellow, transparent thermoplastic resin varnish with the concentration of 20 mass %. Into this thermoplastic resin varnish, 139 g of a thermosetting resin varnish was added, to prepare a resin varnish containing the thermoplastic resin and the thermosetting resin. As the thermosetting resin varnish, use was made of HI 406 (a polyamideimide (PAI) solution containing the resin component 32 mass %) (trade name, manufactured by Hitachi Chemical Co., Ltd.).

### <Preparation of Insulated Wire>

The thus-obtained resin varnish containing the thermoplastic resin and the thermosetting resin (PAE:PEI=10:90) was applied, onto the outer circumference of a copper wire with 1-mm diameter, followed by baking at 520° C., to obtain a wire having a film with thickness 40 μm on the outer circumference of the conductor. The resultant wire was placed in a pressure vessel, followed by subjecting to a pressure treatment under an atmosphere of a carbon dioxide gas at 35° C. and 5.8 MPa for 24 hours, to penetrate the carbon dioxide gas into the wire until reaching the saturation. Then, the resultant wire was taken out from the pressure vessel, and placed in a foaming furnace of a type of a circulating hot air whose temperature was set at 190° C. for one minute, to form air holes in the insulating film to obtain the insulated wire of Example 1, as shown in FIG. 2(a).

### Example 2

A resin varnish was prepared in the same manner as in Example 1, except that the amount to be added of the thermosetting resin varnish in Example 1 was changed to 1,250 g. By using the resin varnish thus obtained (blending ratio of PAI to PEI was PAE:PEI=50:50), the insulated wire of Example 2, as shown in FIG. 2(a), was obtained in the similar manner as in Example 1.

### Example 3

A resin varnish was prepared in the same manner as in Example 1, except that the amount to be added of the thermosetting resin varnish in Example 1 was changed to 11,250 g. By using the resin varnish thus obtained (blending ratio of PAI to PEI was PAI:PEI=90:10), the insulated wire of Example 3, as shown in FIG. 2(a), was obtained in the similar manner as in Example 1.

### Example 4

### Preparation of Resin Varnish Containing Thermoplastic Resin and Thermosetting Resin

Into a 2-L separable flask, 1,600 g of NMP (2-methylpyrrolidone) was placed, and thereto, 400 g of pellets of a polyimide (PI), which is a thermoplastic resin, was added in small portions. The resultant mixture was heated to 110° C., followed by stirring for 5 hours, to obtain a yellow, transparent thermoplastic resin varnish with the concentration of 20 mass %. Into this thermoplastic resin varnish, 1,250 g of a thermosetting resin varnish was added, to prepare a resin varnish containing the thermoplastic resin and the thermosetting resin. As the thermosetting resin varnish, use was made of HI 406 (a PAI solution containing the resin component 32 mass %) (trade name, manufactured by Hitachi Chemical Co., Ltd.).

### <Preparation of Insulated Wire>

The insulated wire of Example 4, as shown in FIG. 2(a), having an insulating film formed from the resin varnish with the blending ratio of PAI to PI being PAI:PI=50:50, was obtained in the same manner as in Example 1, except that the above-obtained resin varnish was used.

### Example 5

### Preparation of Resin Varnish Containing Thermoplastic Resin and Thermosetting Resin

Into a 2-L separable flask, 1,600 g of NMP (2-methylpyrrolidone) was placed, and thereto, 400 g of pellets of a polyetherimide (PEI) resin, which is a thermoplastic resin, was added in small portions. The resultant mixture was heated to 110° C., followed by stirring for 5 hours, to obtain a yellow, transparent thermoplastic resin varnish with the concentration of 20 mass %. Into this thermoplastic resin varnish, 1,250 g of a thermosetting resin varnish was added, to prepare a resin varnish containing the thermoplastic resin and the thermosetting resin. As the thermosetting resin varnish, use was made of a thermally cured product (a PI solution containing the resin component 32 mass %), obtained by a usual method, in which a polyamide acid solution obtained by allowing the reaction of an aromatic tetracarboxylic dianhydride with an aromatic diamine in a polar solvent was imidized by heat treatment in the course of baking, to form the film.

### <Preparation of Insulated Wire>

The insulated wire of Example 5, as shown in FIG. 2(a), having an insulating film formed from the resin varnish with the blending ratio of PI to PEI being PI:PEI=50:50, was obtained in the same manner as in Example 1, except that the above-obtained resin varnish was used.

### Example 6

### Preparation of Resin Varnish Containing Thermoplastic Resin and Thermosetting Resin

Into a 2-L separable flask, 1,600 g of NMP (2-methylpyrrolidone) was placed, and thereto, 400 g of pellets of a polyetherimide (PEI) resin, which is a thermoplastic resin, was added in small portions. The resultant mixture was heated to 110° C., followed by stirring for 5 hours, to obtain a yellow, transparent thermoplastic resin varnish with the concentration of 20 mass %. Into this thermoplastic resin varnish, 1,250 g of a thermosetting resin varnish was added, to prepare a resin varnish containing the thermoplastic resin and the thermosetting resin. As the thermosetting resin varnish, use was made of Isonel 200 (a polyester solution containing the resin component 32 mass %) (manufactured by Schenectady International, Inc.).

### <Preparation of Insulated Wire>

The insulated wire of Example 6, as shown in FIG. 2(a), having an insulating film formed from the resin varnish with the blending ratio of the thermosetting polyester to PEI being Polyester:PEI=50:50, was obtained in the same manner as in Example 1, except that the above-obtained resin varnish was used.

### Example 7

### Preparation of Resin Varnish Containing Thermoplastic Resin and Thermosetting Resin

Into a 2-L separable flask, 1,600 g of NMP (2-methylpyrrolidone) was placed, and thereto, 400 g of pellets of a polycarbonate resin (PC), which is a thermoplastic resin, was added in small portions. The resultant mixture was heated to 110° C., followed by stirring for 5 hours, to obtain a yellow, transparent thermoplastic resin varnish with the concentration of 20 mass %. Into this thermoplastic resin varnish, 1,250 g of a thermosetting resin varnish was added, to prepare a resin varnish containing the thermoplastic resin and the thermosetting resin. As the thermosetting resin varnish, use was made of HI 406 (a PAI solution containing the resin component 32 mass %) (trade name, manufactured by Hitachi Chemical Co., Ltd.).

### <Preparation of Insulated Wire>

The insulated wire of Example 7, as shown in FIG. 2(a), having an insulating film formed from the resin varnish with the blending ratio of PAI to PC being PAI:PC=50:50, was obtained in the same manner as in Example 1, except that the above-obtained resin varnish was used.

### Example 8

### Preparation of Resin Varnish Containing Thermoplastic Resin and Thermosetting Resin

Into a 2-L separable flask, 1,600 g of NMP (2-methylpyrrolidone) was placed, and thereto, 400 g of pellets of a polyethersulfone resin (PES), which is a thermoplastic resin, was added in small portions. The resultant mixture was heated to 110° C., followed by stirring for 5 hours, to obtain a yellow, transparent thermoplastic resin varnish with the concentration of 20 mass %. Into this thermoplastic resin varnish, 1,250 g of a thermosetting resin varnish was added, to prepare a resin varnish containing the thermoplastic resin and the thermosetting resin. As the thermosetting resin varnish, use was made of HI 406 (a PAI solution containing the resin component 32 mass %) (trade name, manufactured by Hitachi Chemical Co., Ltd.).

### <Preparation of Insulated Wire>

The insulated wire of Example 8, as shown in FIG. 2(a), having an insulating film formed from the resin varnish with the blending ratio of PAI to PES being PAI:PES=50:50, was obtained in the same manner as in Example 1, except that the above-obtained resin varnish was used.

### Example 9

### Preparation of Resin Varnish Containing Thermoplastic Resin and Thermosetting Resin

Into a 2-L separable flask, 1,600 g of NMP (2-methylpyrrolidone) was placed, and thereto, 400 g of pellets of a polyphenylsulfone resin (PPSU), which is a thermoplastic resin, was added in small portions. The resultant mixture was heated to 110° C., followed by stirring for 5 hours, to obtain a yellow, transparent thermoplastic resin varnish with the concentration of 20 mass %. Into this thermoplastic resin varnish, 1,250 g of a thermosetting resin varnish was added, to prepare a resin varnish containing the thermoplastic resin and the thermosetting resin. As the thermosetting resin varnish, use was made of HI 406 (a PAI solution containing the resin component 32 mass %) (trade name, manufactured by Hitachi Chemical Co., Ltd.).

### <Preparation of Insulated Wire>

The insulated wire of Example 9, as shown in FIG. 2(a), having an insulating film formed from the resin varnish with the blending ratio of PAI to PPSU being PAI:PPSU=50:50, was obtained in the same manner as in Example 1, except that the above-obtained resin varnish was used.

### Example 10

### Preparation of Resin Varnish Containing Thermoplastic Resin and Thermosetting Resin

Into a 2-L separable flask, 1,600 g of NMP (2-methylpyrrolidone) was placed, and thereto, 400 g of pellets of a polysulfone resin (PSU), which is a thermoplastic resin, was added in small portions. The resultant mixture was heated to 110° C., followed by stirring for 5 hours, to obtain a yellow, transparent thermoplastic resin varnish with the concentration of 20 mass %. Into this thermoplastic resin varnish, 1,250 g of a thermosetting resin varnish was added, to prepare a resin varnish containing the thermoplastic resin and the thermosetting resin. As the thermosetting resin varnish, use was made of HI 406 (a PAI solution containing the resin component 32 mass %) (trade name, manufactured by Hitachi Chemical Co., Ltd.).

### <Preparation of Insulated Wire>

The insulated wire of Example 10, as shown in FIG. 2(a), having an insulating film formed from the resin varnish with the blending ratio of PAI to PSU being PAI:PSU=50:50, was obtained in the same manner as in Example 1, except that the above-obtained resin varnish was used.

### Example 11

### Preparation of Resin Varnish Containing Thermoplastic Resin and Thermosetting Resin

Into a 2-L separable flask, 1,600 g of NMP (2-methylpyrrolidone) was placed, and thereto, 400 g of pellets of a polyarylate resin (PAR), which is a thermoplastic resin, was added in small portions. The resultant mixture was heated to 110° C., followed by stirring for 5 hours, to obtain a yellow, transparent thermoplastic resin varnish with the concentration of 20 mass %. Into this thermoplastic resin varnish, 1,250 g of a thermosetting resin varnish was added, to prepare a resin varnish containing the thermoplastic resin and the thermosetting resin. As the thermosetting resin varnish, use was made of HI 406 (a PAI solution containing the resin component 32 mass %) (trade name, manufactured by Hitachi Chemical Co., Ltd.).

### <Preparation of Insulated Wire>

The insulated wire of Example 11, as shown in FIG. 2(a), having an insulating film formed from the resin varnish with the blending ratio of PAI to PAR being PAI:PAR=50:50, was obtained in the same manner as in Example 1, except that the above-obtained resin varnish was used.

### Comparative Example 1

### Preparation of Resin Varnish Containing Thermosetting Resin, and Preparation of Insulated Wire Using the Same

Only the resin varnish of PAI as used in Example 1, was applied onto the outer circumference of a copper wire with 1-mm diameter, followed by baking at 520° C., to obtain the insulated wire of Comparative Example 1 having a film of 40-μm thickness formed on the outer circumference of the conductor. Then, no treatment to form air holes was conducted.

### Comparative Example 2

### Preparation of Resin Varnish Containing Thermoplastic Resin

Into a 2-L separable flask, 1,600 g of NMP (2-methylpyrrolidone) was placed, and thereto, 400 g of pellets of a polyetherimide resin (PEI), which is a thermoplastic resin, was added in small portions. The resultant mixture was heated to 110° C., followed by stirring for 5 hours, to obtain a yellow, transparent thermoplastic resin varnish with the concentration of 25 mass %.

### <Preparation of Insulated Wire>

The insulated wire of Comparative Example 2, having an insulating film formed from the PEI, was obtained in the same manner as in Comparative Example 1, except that the resin varnish containing only the above-mentioned thermoplastic resin was used. Then, no treatment to form air holes was conducted, as in the case of the insulated wire of Comparative Example 2.

### Comparative Example 3

### Preparation of Resin Varnish Containing Thermoplastic Resin and Thermosetting Resin

Into a 2-L separable flask, 1,600 g of NMP (2-methylpyrrolidone) was placed, and thereto, 400 g of pellets of a polyetherimide resin (PEI), which is a thermoplastic resin, was added in small portions. The resultant mixture was heated to 110° C., followed by stirring for 5 hours, to obtain a yellow, transparent thermoplastic resin varnish with the concentration of 20 mass %. Into this thermoplastic resin varnish, 66 g of a thermosetting resin varnish was added, to prepare a resin varnish containing the thermoplastic resin and the thermosetting resin. As the thermosetting resin varnish, use was made of HI 406 (a PAI solution containing the resin component 32 mass %) (trade name, manufactured by Hitachi Chemical Co., Ltd.).

### <Preparation of Insulated Wire>

The insulated wire of Comparative Example 3, having an insulating film formed from the resin varnish with the blending ratio of PAI to PEI being PAI:PEI=5:95, was obtained in the same manner as in Example 1, except that the above-obtained resin varnish was used.

### Comparative Example 4

### Preparation of Resin Varnish Containing Thermoplastic Resin and Thermosetting Resin

Into a 2-L separable flask, 160 g of NMP (2-methylpyrrolidone) was placed, and thereto, 40 g of pellets of a polyetherimide resin (PEI), which is a thermoplastic resin, was added in small portions. The resultant mixture was heated to 110° C., followed by stirring for 5 hours, to obtain a yellow, transparent thermoplastic resin varnish with the concentration of 20 mass %. Into this thermoplastic resin varnish, 2,375 g of a thermosetting resin varnish was added, to prepare a resin varnish containing the thermoplastic resin and the thermosetting resin. As the thermosetting resin varnish, use was made of HI 406 (a PAI solution containing the resin component 32 mass %) (trade name, manufactured by Hitachi Chemical Co., Ltd.).

### <Preparation of Insulated Wire>

The insulated wire of Comparative Example 4, having an insulating film formed from the resin varnish with the blending ratio of PAI to PEI being PAI:PEI=95:5, was obtained in the same manner as in Example 1, except that the above-obtained resin varnish was used.

### 2. Test and Evaluation of Insulated Wire

With respect to the insulated wires of Examples 1 to 11 and Comparative Examples 1 to 4, the dielectric breakdown voltage, the effective dielectric constant, the partial discharge inception voltage (PDIV), and the abrasion resistance were measured, and the performances thereof were evaluated.

### (Thickness of Insulating Layer Having Air Holes and Average Air Hole Diameter)

The thickness of the insulating layer having air holes and the average diameter of the air holes were determined from SEM photomicrographs of cross sections of the insulated wires.

### (Air Hole Magnification)

The density (ρf) of the insulating film of the insulated wire and the density (ρs) before formation of air holes were measured, and the air hole magnification was calculated by the ratio (ρf/ρs).

### (Abrasion Resistance)

The abrasion resistance was measured with a reciprocal abrasion tester. The reciprocal abrasion tester is a tester to measure the number of exposures of the conductor occurred on the film surface, when the surface of the insulated wire is scratched by a needle under a given load applied, to measure the film strength. Evaluation on the abrasion resistance was made whether or not the reciprocal abrasion number would reach 200, under the applied load of 300 g. In Tables 1 to 3, the case where the number of reciprocal abrasions was 200 or more is shown by “◯”, which was judged to satisfy the criteria in the test “good”. The case where the number for reciprocal abrasions was less than 200 is shown by “x”, which was judged to fail in satisfying the criteria in the test “poor”.

### (Dielectric Breakdown Voltage)

The dielectric breakdown voltage of the insulated wire was evaluated, according to an aluminum foil method as described below.

An insulated wire was cut out in the length of about 200 mm, and an aluminum foil with 10-mm width was wound around on the vicinity of the central portion thereof; then, an alternating voltage of 50-Hz sinusoidal wave was applied between the aluminum foil and the conductor, to measure the voltage (effective value) causing dielectric breakdown while continuously raising the voltage; and this value was taken as the dielectric breakdown voltage. The measurement temperature was set at room temperature. The breakdown voltage of 10 kV or more was judged to satisfy the criteria in the test, and the breakdown voltage of less than 10 kV was judged to fail in satisfying the criteria in the test.

### (Partial Discharge Initiation Voltage)

Specimens were prepared by combining two insulated wires of any one of Examples and Comparative Examples into a twisted form, an alternating voltage with sine wave 50 Hz was applied between the respective two conductors twisted, and while the voltage was continuously raised, the voltage (effective value) at which the amount of discharged charge was 10 pC was measured. The measurement temperature was set at the room temperature. For the measurement of the partial discharge-occurring voltage (partial discharge initiation voltage), a partial discharge tester (KPD2050 (trade name), manufactured by Kikusui Electronics Corp.) was used. A sample specimen which had a partial discharge initiation voltage of 900 Vp or higher, was judged to pass the test criteria (“good”), and a sample specimen which had a partial discharge initiation voltage of less than 900 Vp, was judged not to pass the test criteria (“poor”).

The evaluation results of the insulated wires obtained in Examples 1 to 11 and Comparative Examples 1 to 4 are shown in Tables 1 to 3.

TABLE 1

| | | | Ex 1 | Ex 2 | Ex 3 | Ex 4 | Ex 5 | Ex 6 |
|---|---|---|---|---|---|---|---|---|
| Insulating | Layer thickness (μm) | | 40 | 40 | 40 | 40 | 40 | 40 |
| layer | Resins | | PAI/PEI | PAI/PEI | PAI/PEI | PAI/PI | PI/PEI | Polyester/ |
| | (thermosetting resin/thermoplastic resin) | | | | | | | PEI |
| | Blended | Thermosetting resin (%) | 10 | 50 | 90 | 50 | 50 | 50 |
| | ratio | Thermoplastic resin (%) | 90 | 50 | 10 | 50 | 50 | 50 |

| | | | | | | |
|---|---|---|---|---|---|---|
| Average air hole diameter (μm) | 0.8 | 0.8 | 0.8 | 0.8 | 0.8 | 0.8 |
| Air hole magnification | 1.1 | 1.1 | 1.1 | 1.1 | 1.1 | 1.1 |
| Abrasion resistance | ∘ | ∘ | ∘ | ∘ | ∘ | ∘ |
| Dielectric breakdown voltage (kV) | 13 | 13 | 13 | 13 | 13 | 13 |
| Partial discharge-occurring voltage (Vp) | 930 | 930 | 930 | 930 | 930 | 930 |

“Ex” means Example according to the present invention.

TABLE 2

| | | | Ex 7 | Ex 8 | Ex 9 | Ex 10 | Ex 11 |
|---|---|---|---|---|---|---|---|
| Insulating | Layer thickness (μm) | | 40 | 40 | 40 | 40 | 40 |
| layer | Resins | | PAI/PC | PAI/PES | PAI/PPSU | PAI/PSU | PAI/PAR |
| | (thermosetting resin/thermoplastic resin) | | | | | | |
| | Blended | Thermosetting resin (%) | 50 | 50 | 50 | 50 | 50 |
| | ratio | Thermoplastic resin (%) | 50 | 50 | 50 | 50 | 50 |

| | | | | | |
|---|---|---|---|---|---|
| Average air hole diameter (μm) | 0.8 | 0.8 | 0.8 | 0.8 | 0.8 |
| Air hole magnification | 1.1 | 1.1 | 1.1 | 1.1 | 1.1 |
| Abrasion resistance | ∘ | ∘ | ∘ | ∘ | ∘ |
| Dielectric breakdown voltage (kV) | 13 | 13 | 13 | 13 | 13 |
| Partial discharge-occurring voltage (Vp) | 930 | 930 | 930 | 930 | 930 |

“Ex” means Example according to the present invention.

TABLE 3

| | | | C | | | |
|---|---|---|---|---|---|---|
| | | | Ex 1 | C Ex 2 | C Ex 3 | C Ex 4 |
| Insulating | Layer thickness (μm) | | 40 | 40 | 40 | 40 |
| layer | Resins | | PAI | PEI | PAI/PEI | PAI/PEI |
| | (thermosetting resin/ | | only | only | | |
| | thermoplastic resin) | | | | | |
| | Blended | Thermosetting | 100 | 0 | 5 | 95 |
| | ratio | resin (%) | | | | |
| | | Thermoplastic | 0 | 100 | 95 | 5 |
| | | resin (%) | | | | |

| | | | | |
|---|---|---|---|---|
| Average air hole diameter (μm) | — | — | 0.8 | — |
| Air hole magnification | — | — | 1.3 | Not |
| | | | | foamed |
| Abrasion resistance | ∘ | x | x | ∘ |
| Dielectric breakdown voltage (kV) | 13 | 13 | 13 | 13 |
| Partial discharge-occurring | 850 | 820 | 930 | 830 |
| voltage (Vp) | | | | |

“C Ex” means Comparative Example.

As shown in Examples 1 to 11, the insulated wires, each of which were provided with the insulating film, obtained by applying the resin varnish containing a thermosetting resin and a thermoplastic resin onto the outer circumference of the conductor followed by baking, and having fine air holes, exhibited a partial discharge-occurring voltage as high as 930 Vp, and were judged to satisfy the criteria in the abrasion resistance test.

On the contrary, the insulated wire, obtained by applying and baking only the varnish of a PAI resin, which is a thermosetting resin, was low in the partial discharge-occurring voltage (Comparative Example 1). Further, the insulated wire, obtained by applying and baking only the resin varnish not containing any thermosetting resin, was low in the partial discharge-occurring voltage, and was poor in the result in abrasion resistance (Comparative Example 2).

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2010-1067666 filed in Japan on May 6, 2010, which is entirely herein incorporated by reference.

### REFERENCE SIGNS LIST

1 Conductor
2 Insulating film having air holes
3 Fine air holes
4 Insulating layer having no air holes
10 Insulated wire

1. An insulated wire, having a conductor whose outer circumference is covered with an insulating film, wherein the insulating film is composed of a cured product of a thermosetting resin composition containing a thermoplastic resin, and the insulating film has fine air holes.

2. The insulated wire according to claim 1, wherein an average diameter of the air holes is 1 μm or less.

3. The insulated wire according to claim 1, wherein a ratio A/B is within the range of 10/90 to 90/10, in which A is a mass of a resin component of the thermosetting resin, and B is a mass of the thermoplastic resin.

4. The insulated wire according to claim 2, wherein a ratio A/B is within the range of 10/90 to 90/10, in which A is a mass of a resin component of the thermosetting resin, and B is a mass of the thermoplastic resin.

5. The insulated wire according to claim 1, wherein the thermoplastic resin is an amorphous resin.

6. The insulated wire according to claim 4, wherein the amorphous resin is at least one selected from the group consisting of a polyetherimide, a polycarbonate, a polyethersulfon, a polyphenylsulfone, a polysulfone, a thermoplastic polyimide, and a polyarylate.

7. The insulated wire according to claim 1, wherein the thermosetting resin is at least one selected from the group consisting of a polyester, a polyimide, and a polyamideimide.

8. An electrical equipment, which comprises the insulated wire according to claim 1.

9. A method of producing an insulated wire, comprising the steps of:
applying a resin varnish containing a thermosetting resin and a thermoplastic resin onto an outer circumference of a conductor directly or indirectly, followed by baking, thereby for forming an insulating film;
keeping the resultant insulating film in an atmosphere of an inert gas under a pressurized condition, thereby for bringing the inert gas be contained into the resultant insulating film composed of the resin varnish baked; and
heating the resultant insulating film composed of the resin varnish baked, under a usual pressure, thereby for forming air holes.
